(19) United States
(12) Patent Application Publication
(10) Pub. No.: US 2010/0189182 A1
(43) Pub. Date: Jul. 29, 2010

(54) METHOD AND APPARATUS FOR VIDEO CODING AND DECODING

(75) Inventor: Miska Matias Hannuksela, Ruutana (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/694,753

(22) Filed: Jan. 27, 2010

Related U.S. Application Data
(60) Provisional application No. 61/148,017, filed on Jan. 28, 2009.

(51) Int. Cl. H04N 7/26; H04N 7/24

(52) U.S. Cl. 375/240.25; 375/E07.003; 375/E07.027

(57) ABSTRACT

A method comprises receiving a bitstream including a sequence of access units; decoding a first decodable access unit in the bitstream; determining whether a next decodable access unit in the bitstream can be decoded before an output time of the next decodable access unit; and skipping decoding of the next decodable access unit based on determining that the next decodable access unit cannot be decoded before the output time of the next decodable access unit.

### RELATED APPLICATIONS

The present application was originally filed as U.S. Patent Application No. 61/148,017 on Jan. 28, 2009, which is incorporated herein by reference in its entirety.

### FIELD OF INVENTION

The present invention relates generally to the field of video coding and, more specifically, to efficient startup of decoding of encoded data.

### BACKGROUND OF THE INVENTION

This section is intended to provide a background or context to the invention that is recited in the claims. The description herein may include concepts that may be pursued, but are not necessarily ones that have been previously conceived or pursued. Therefore, unless otherwise indicated herein, what is described in this section is not prior art to the description and claims in this application and is not admitted to be prior art by inclusion in this section.

In order to facilitate communication of video content over one or more networks, several coding standards have been developed. Video coding standards include ITU-T H.261, ISO/IEC MPEG-1 Video, ITU-T H.262 or ISO/IEC MPEG-2 Video, ITU-T H.263, ISO/IEC MPEG-4 Visual, ITU-T H.264 (also know as ISO/IEC MPEG-4 AVC), and the scalable video coding (SVC) extension of H.264/AVC. In addition, there are currently efforts underway to develop new video coding standards. One such standard under development is the multi-view video coding (MVC) standard, which will become another extension to H.264/AVC.

The Advanced Video Coding (H.264/AVC) standard is known as ITU-T Recommendation H.264 and ISO/IEC International Standard 14496-10, also known as MPEG-4 Part 10 Advanced Video Coding (AVC). There have been several versions of the H.264/AVC standard, each integrating new features to the specification. Version 8 refers to the standard including the Scalable Video Coding (SVC) amendment. A new version that is currently being approved includes the Multiview Video Coding (MVC) amendment.

Multi-level temporal scalability hierarchies enabled by H.264/AVC and SVC are suggested to be used due to their significant compression efficiency improvement. However, the multi-level hierarchies also cause a significant delay between starting of the decoding and starting of the rendering. The delay is caused by the fact that decoded pictures have to be reordered from their decoding order to the output/display order. Consequently, when accessing a stream from a random position, the start-up delay is increased, and similarly the tune-in delay to a multicast or broadcast is increased compared to those of non-hierarchical temporal scalability.

### SUMMARY OF THE INVENTION

In one aspect of the invention, a method comprises receiving a bitstream including a sequence of access units; decoding a first decodable access unit in the bitstream; determining whether a next decodable access unit in the bitstream can be decoded before an output time of the next decodable access unit; and skipping decoding of the next decodable access unit based on determining that the next decodable access unit cannot be decoded before the output time of the next decodable access unit.

In one embodiment, the method further comprises skipping decoding of any access units depending on the next decodable access unit. In one embodiment, the method further comprises decoding the next decodable access unit based on determining that the next decodable access unit can be decoded before the output time of the next decodable access unit. The determining and either the skipping decoding or the decoding the next decodable access unit until the bitstream contains no more access units may be repeated. In one embodiment, the decoding of the first decodable access unit may include starting decoding at a non-continuous position relative to a previous decoding position.

In another aspect of the invention, a method comprises receiving a request for a bitstream including a sequence of access units from a receiver; encapsulating a first decodable access unit for the bitstream for transmission; determining whether a next decodable access unit in the bitstream can be encapsulated before a transmission time of the next decodable access unit; and skipping encapsulation of the next decodable access unit based on determining that the next decodable access unit cannot be encapsulated before the transmission time of the next decodable access unit; and transmitting the bitstream to the receiver.

In another aspect of the invention, a method comprises generating instructions for decoding a bitstream including a sequence of access units, the instructions comprising: decoding a first decodable access unit in the bitstream; determining whether a next decodable access unit in the bitstream can be decoded before an output time of the next decodable access unit; and skipping decoding of the next decodable access unit based on determining that the next decodable access unit cannot be decoded before the output time of the next decodable access unit.

In another aspect of the invention, a method comprises decoding a bitstream including a sequence of access units on the basis of instructions, the instructions comprising: decoding a first decodable access unit in the bitstream; determining whether a next decodable access unit in the bitstream can be decoded before an output time of the next decodable access unit; and skipping decoding of the next decodable access unit based on determining that the next decodable access unit cannot be decoded before the output time of the next decodable access unit.

In another aspect of the invention, a method comprises generating instructions for encapsulating a bitstream including a sequence of access units, the instructions comprising: encapsulating a first decodable access unit for the bitstream for transmission; determining whether a next decodable access unit in the bitstream can be encapsulated before a transmission time of the next decodable access unit; and skipping encapsulation of the next decodable access unit based on determining that the next decodable access unit cannot be encapsulated before the transmission time of the next decodable access unit.

In another aspect of the invention, a method comprises encapsulating a bitstream including a sequence of access units based on instructions, the instructions comprising: encapsulating a first decodable access unit for the bitstream for transmission; determining whether a next decodable access unit in the bitstream can be encapsulated before a transmission time of the next decodable access unit; and skipping encapsulation of the next decodable access unit based on determining that the next decodable access unit cannot be encapsulated before the transmission time of the next decodable access unit.

In another aspect of the invention, a method comprises selecting a first set of coded data units from a bitstream, wherein a sub-bitstream comprising the bitstream excluding the first set of coded data units results is decodable into a first set of decoded data units, the bitstream is decodable into a second set of decoded data units, a first buffering resource is sufficient to arrange the first set of decoded data units into an output order, a second buffering resource is sufficient to arrange the second set of decoded data units into an output order, and the first buffering resource is less than the second buffering resource. In one embodiment, the first buffering resource and the second buffering resource are in terms of an initial time for decoded data unit buffering. In another embodiment, the first buffering resource and the second buffering resource are in terms of an initial buffer occupancy for decoded data unit buffering.

In another aspect of the invention, an apparatus comprises a decoder configured to decode a first decodable access unit in the bitstream; determine whether a next decodable access unit in the bitstream can be decoded before an output time of the next decodable access unit; and skip decoding of the next decodable access unit based on determining that the next decodable access unit cannot be decoded before the output time of the next decodable access unit.

In another aspect of the invention, an apparatus comprises an encoder configured to encapsulate a first decodable access unit for the bitstream for transmission; determine whether a next decodable access unit in the bitstream can be encapsulated before a transmission time of the next decodable access unit; and skip encapsulation of the next decodable access unit based on determining that the next decodable access unit cannot be encapsulated before the transmission time of the next decodable access unit.

In another aspect of the invention, an apparatus comprises a file generator configured to generate instructions to: decode a first decodable access unit in the bitstream; determine whether a next decodable access unit in the bitstream can be decoded before an output time of the next decodable access unit; and skip decoding of the next decodable access unit based on determining that the next decodable access unit cannot be decoded before the output time of the next decodable access unit

In another aspect of the invention, an apparatus comprises a file generator configured to generate instructions to: encapsulate a first decodable access unit for the bitstream for transmission; determine whether a next decodable access unit in the bitstream can be encapsulated before a transmission time of the next decodable access unit; and skip encapsulation of the next decodable access unit based on determining that the next decodable access unit cannot be encapsulated before the transmission time of the next decodable access unit

In another aspect of the invention, an apparatus comprises a processor and a memory unit communicatively connected to the processor. The memory unit includes computer code for decoding a first decodable access unit in the bitstream; computer code for determining whether a next decodable access unit in the bitstream can be decoded before an output time of the next decodable access unit; and computer code for skipping decoding of the next decodable access unit based on determining that the next decodable access unit cannot be decoded before the output time of the next decodable access unit.

In another aspect of the invention, an apparatus comprises a processor and a memory unit communicatively connected to the processor. The memory unit includes computer code for encapsulating a first decodable access unit for the bitstream for transmission; computer code for determining whether a next decodable access unit in the bitstream can be encapsulated before a transmission time of the next decodable access unit; and computer code for skipping encapsulation of the next decodable access unit based on determining that the next decodable access unit cannot be encapsulated before the transmission time of the next decodable access unit.

In another aspect of the invention, a computer program product is embodied on a computer-readable medium and comprises computer code for decoding a first decodable access unit in the bitstream; computer code for determining whether a next decodable access unit in the bitstream can be decoded before an output time of the next decodable access unit; and computer code for skipping decoding of the next decodable access unit based on determining that the next decodable access unit cannot be decoded before the output time of the next decodable access unit.

In another aspect of the invention, a computer program product is embodied on a computer-readable medium and comprises computer code for encapsulating a first decodable access unit for the bitstream for transmission; computer code for determining whether a next decodable access unit in the bitstream can be encapsulated before a transmission time of the next decodable access unit; and computer code for skipping encapsulation of the next decodable access unit based on determining that the next decodable access unit cannot be encapsulated before the transmission time of the next decodable access unit.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates an exemplary hierarchical coding structure with temporal scalability;

FIG. 2 illustrates an exemplary box in accordance with the ISO base media file format;

FIG. 3 is an exemplary box illustrating sample grouping;

FIG. 4 illustrates an exemplary box containing a movie fragment including a SampletoToGroup box;

FIG. 5 illustrates the protocol stack for Digital Video Broadcasting-Handheld (DVB-H);

FIG. 6 illustrates the structure of a Multi-Protocol Encapsulation Forward Error Correction (MPE-FEC) frame;

FIGS. 7(a)-(c) illustrate an example hierarchically scalable bitstream with five temporal levels;

FIG. 8 is a flowchart illustrating an example implementation in accordance with an embodiment of the present invention;

FIG. 9 illustrates an example application of the method of FIG. 8 to the sequence of FIG. 7;

FIG. 10 illustrates another example sequence in accordance with embodiments of the present invention;

FIGS. 11(a)-(c) illustrate another example sequence in accordance with embodiments of the present invention;

FIG. 12 is an overview diagram of a system within which various embodiments of the present invention may be implemented;

FIG. 13 illustrates a perspective view of an exemplary electronic device which may be utilized in accordance with the various embodiments of the present invention;

FIG. 14 is a schematic representation of the circuitry which may be included in the electronic device of FIG. 13; and

FIG. 15 is a graphical representation of a generic multimedia communication system within which various embodiments may be implemented.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

As noted above, the Advanced Video Coding (H.264/AVC) standard is known as ITU-T Recommendation H.264 and ISO/IEC International Standard 14496-10, also known as MPEG-4 Part 10 Advanced Video Coding (AVC). There have been several versions of the H.264/AVC standard, each integrating new features to the specification. Version 8 refers to the standard including the Scalable Video Coding (SVC) amendment. A new version that is currently being approved includes the Multiview Video Coding (MVC) amendment.

Similarly to earlier video coding standards, the bitstream syntax and semantics as well as the decoding process for error-free bitstreams are specified in H.264/AVC. The encoding process is not specified, but encoders must generate conforming bitstreams. Bitstream and decoder conformance can be verified with the Hypothetical Reference Decoder (HRD), which is specified in Annex C of H.264/AVC. The standard contains coding tools that help in coping with transmission errors and losses, but the use of the tools in encoding is optional and no decoding process has been specified for erroneous bitstreams.

The elementary unit for the input to an H.264/AVC encoder and the output of an H.264/AVC decoder is a picture. A picture may either be a frame or a field. A frame comprises a matrix of luma samples and corresponding chroma samples. A field is a set of alternate sample rows of a frame and may be used as encoder input, when the source signal is interlaced. A macroblock is a 16×16 block of luma samples and the corresponding blocks of chroma samples. A picture is partitioned to one or more slice groups, and a slice group contains one or more slices. A slice includes an integer number of macroblocks ordered consecutively in the raster scan within a particular slice group.

The elementary unit for the output of an H.264/AVC encoder and the input of an H.264/AVC decoder is a Network Abstraction Layer (NAL) unit. Decoding of partial or corrupted NAL units is typically remarkably difficult. For transport over packet-oriented networks or storage into structured files, NAL units are typically encapsulated into packets or similar structures. A bytestream format has been specified in H.264/AVC for transmission or storage environments that do not provide framing structures. The bytestream format separates NAL units from each other by attaching a start code in front of each NAL unit. To avoid false detection of NAL unit boundaries, encoders must run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention is performed always regardless of whether the bytestream format is in use or not.

The bitstream syntax of H.264/AVC indicates whether or not a particular picture is a reference picture for inter prediction of any other picture. Consequently, a picture not used for prediction (a non-reference picture) can be safely disposed. Pictures of any coding type (I, P, B) can non-reference pictures in H.264/AVC. The NAL unit header indicates the type of the NAL unit and whether a coded slice contained in the NAL unit is a part of a reference picture or a non-reference picture.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture must be marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control requires the presence of memory management control operation (MMCO) parameters in the bitstream. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

The reference picture for inter prediction is indicated with an index to a reference picture list. The index is coded with variable length coding, i.e., the smaller the index is, the shorter the corresponding syntax element becomes. Two reference picture lists are generated for each bi-predictive slice of H.264/AVC, and one reference picture list is formed for each inter-coded slice of H.264/AVC. A reference picture list is constructed in two steps: first, an initial reference picture list is generated, and then the initial reference picture list may be reordered by reference picture list reordering (RPLR) commands contained in slice headers. The RPLR commands indicate the pictures that are ordered to the beginning of the respective reference picture list.

The frame_num syntax element is used for various decoding processes related to multiple reference pictures. The value of frame_num for IDR pictures is required to be 0. The value of frame_num for non-IDR pictures is required to be equal to the frame_num of the previous reference picture in decoding order incremented by 1 (in modulo arithmetic, i.e., the value of frame_num wrap over to 0 after a maximum value of frame_num).

The hypothetical reference decoder (HRD), specified in Annex C of H.264/AVC, is used to check bitstream and decoder conformance. The HRD contains a coded picture buffer (CPB), an instantaneous decoding process, a decoded picture buffer (DPB), and an output picture cropping block. The CPB and the instantaneous decoding process are specified similarly to any other video coding standard, and the output picture cropping block simply crops those samples from the decoded picture that are outside the signaled output picture extents. The DPB was introduced in H.264/AVC in order to control the required memory resources for decoding of conformant bitstreams. There are two reasons to buffer decoded pictures, for references in inter prediction and for reordering decoded pictures into output order. As H.264/AVC provides a great deal of flexibility for both reference picture marking and output reordering, separate buffers for reference picture buffering and output picture buffering could have been a waste of memory resources. Hence, the DPB includes a unified decoded picture buffering process for reference pictures and output reordering. A decoded picture is removed from the DPB when it is no longer used as reference and needed for output. The maximum size of the DPB that bitstreams are allowed to use is specified in the Level definitions (Annex A) of H.264/AVC.

There are two types of conformance for decoders: output timing conformance and output order conformance. For output timing conformance, a decoder must output pictures at identical times compared to the HRD. For output order conformance, only the correct order of output picture is taken into account. The output order DPB is assumed to contain a maximum allowed number of frame buffers. A frame is removed from the DPB when it is no longer used as reference and needed for output. When the DPB becomes full, the earliest frame in output order is output until at least one frame buffer becomes unoccupied.

NAL units can be categorized into Video Coding Layer (VCL) NAL units and non-VCL NAL units. VCL NAL units are either coded slice NAL units, coded slice data partition NAL units, or VCL prefix NAL units. Coded slice NAL units contain syntax elements representing one or more coded macroblocks, each of which corresponds to a block of samples in the uncompressed picture. There are four types of coded slice NAL units: coded slice in an Instantaneous Decoding Refresh (IDR) picture, coded slice in a non-IDR picture, coded slice of an auxiliary coded picture (such as an alpha plane) and coded slice in scalable extension (SVC). A set of three coded slice data partition NAL units contains the same syntax elements as a coded slice. Coded slice data partition A comprises macroblock headers and motion vectors of a slice, while coded slice data partition B and C include the coded residual data for intra macroblocks and inter macroblocks, respectively. It is noted that the support for slice data partitions is not included in the Baseline or High profile of H.264/AVC. A VCL prefix NAL unit precedes a coded slice of the base layer in SVC bitstreams and contains indications of the scalability hierarchy of the associated coded slice.

A non-VCL NAL unit may be of one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets are essential for the reconstruction of decoded pictures, whereas the other non-VCL NAL units are not necessary for the reconstruction of decoded sample values and serve other purposes presented below. Parameter sets and the SEI NAL unit are reviewed in depth in the following paragraphs. The other non-VCL NAL units are not essential for the scope of the thesis and therefore not described.

In order to transmit infrequently changing coding parameters robustly, the parameter set mechanism was adopted to H.264/AVC. Parameters that remain unchanged through a coded video sequence are included in a sequence parameter set. In addition to the parameters that are essential to the decoding process, the sequence parameter set may optionally contain video usability information (VUI), which includes parameters that are important for buffering, picture output timing, rendering, and resource reservation. A picture parameter set contains such parameters that are likely to be unchanged in several coded pictures. No picture header is present in H.264/AVC bitstreams but the frequently changing picture-level data is repeated in each slice header and picture parameter sets carry the remaining picture-level parameters. H.264/AVC syntax allows many instances of sequence and picture parameter sets, and each instance is identified with a unique identifier. Each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets using a more reliable transmission mechanism compared to the protocols used for the slice data. For example, parameter sets can be included as a parameter in the session description for H.264/AVC RTP sessions. It is recommended to use an out-of-band reliable transmission mechanism whenever it is possible in the application in use. If parameter sets are transmitted in-band, they can be repeated to improve error robustness.

An SEI NAL unit contains one or more SEI messages, which are not required for the decoding of output pictures but assist in related processes, such as picture output timing, rendering, error detection, error concealment, and resource reservation. Several SEI messages are specified in H.264/AVC, and the user data SEI messages enable organizations and companies to specify SEI messages for their own use. H.264/AVC contains the syntax and semantics for the specified SEI messages but no process for handling the messages in the recipient is defined. Consequently, encoders are required to follow the H.264/AVC standard when they create SEI messages, and decoders conforming to the H.264/AVC standard are not required to process SEI messages for output order conformance. One of the reasons to include the syntax and semantics of SEI messages in H.264/AVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture includes the VCL NAL units that are required for the decoding of the picture. A coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded.

An access unit includes a primary coded picture and those NAL units that are associated with it. The appearance order of NAL units within an access unit is constrained as follows. An optional access unit delimiter NAL unit may indicate the start of an access unit. It is followed by zero or more SEI NAL units. The coded slices or slice data partitions of the primary coded picture appear next, followed by coded slices for zero or more redundant coded pictures.

A coded video sequence is defined to be a sequence of consecutive access units in decoding order from an IDR access unit, inclusive, to the next IDR access unit, exclusive, or to the end of the bitstream, whichever appears earlier.

SVC is specified in Annex G of the latest release of H.264/AVC: ITU-T Recommendation H.264 (November 2007), “Advanced video coding for generic audiovisual services.”

In scalable video coding, a video signal can be encoded into a base layer and one or more enhancement layers constructed. An enhancement layer enhances the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). It should be mentioned that support of FGS has been dropped from the latest SVC draft, but the support is available in earlier SVC drafts, e.g., in JVT-U201, “Joint Draft 8 of SVC Amendment”, 21^{st} JVT meeting, Hangzhou, China, October 2006, available from http://ftp3.itu.ch/av-arch/jvt-site/2006_{—}10_Hangzhou/JVT-U201.zip. In contrast to FGS, the scalability provided by those enhancement layers that cannot be truncated is referred to as coarse-grained (granularity) scalability (CGS). It collectively includes the traditional quality (SNR) scalability and spatial scalability. The SVC draft standard also supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_base_rep_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id.” A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL-1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_base_rep_flag” is set equal to 1. An enhancement representation, also referred to as a decoded picture, results from the regular decoding process in which all the layer representations that are present for the highest dependency representation are decoded.

Each H.264/AVC VCL NAL unit (with NAL unit type in the scope of 1 to 5) is preceded by a prefix NAL unit in an SVC bitstream. A compliant H.264/AVC decoder implementation ignores prefix NAL units. The prefix NAL unit includes the “temporal_id” value and hence an SVC decoder, that decodes the base layer, can learn from the prefix NAL units the temporal scalability hierarchy. Moreover, the prefix NAL unit includes reference picture marking commands for base representations.

SVC uses the same mechanism as H.264/AVC to provide temporal scalability. Temporal scalability provides refinement of the video quality in the temporal domain, by giving flexibility of adjusting the frame rate. A review of temporal scalability is provided in the subsequent paragraphs.

The earliest scalability introduced to video coding standards was temporal scalability with B pictures in MPEG-1 Visual. In this B picture concept, a B picture is bi-predicted from two pictures, one preceding the B picture and the other succeeding the B picture, both in display order. In bi-prediction, two prediction blocks from two reference pictures are averaged sample-wise to get the final prediction block. Conventionally, a B picture is a non-reference picture (i.e., it is not used for inter-picture prediction reference by other pictures). Consequently, the B pictures could be discarded to achieve a temporal scalability point with a lower frame rate. The same mechanism was retained in MPEG-2 Video, H.263 and MPEG-4 Visual.

In H.264/AVC, the concept of B pictures or B slices has been changed. The definition of B slice is as follows: A slice that may be decoded using intra prediction from decoded samples within the same slice or inter prediction from previously-decoded reference pictures, using at most two motion vectors and reference indices to predict the sample values of each block. Both the bi-directional prediction property and the non-reference picture property of the conventional B picture concept are no longer valid. A block in a B slice may be predicted from two reference pictures in the same direction in display order, and a picture including B slices may be referred by other pictures for inter-picture prediction.

In H.264/AVC, SVC and MVC, temporal scalability can be achieved by using non-reference pictures and/or hierarchical inter-picture prediction structure. Using only non-reference pictures is able to achieve similar temporal scalability as using conventional B pictures in MPEG-1/2/4, by discarding non-reference pictures. Hierarchical coding structure can achieve more flexible temporal scalability.

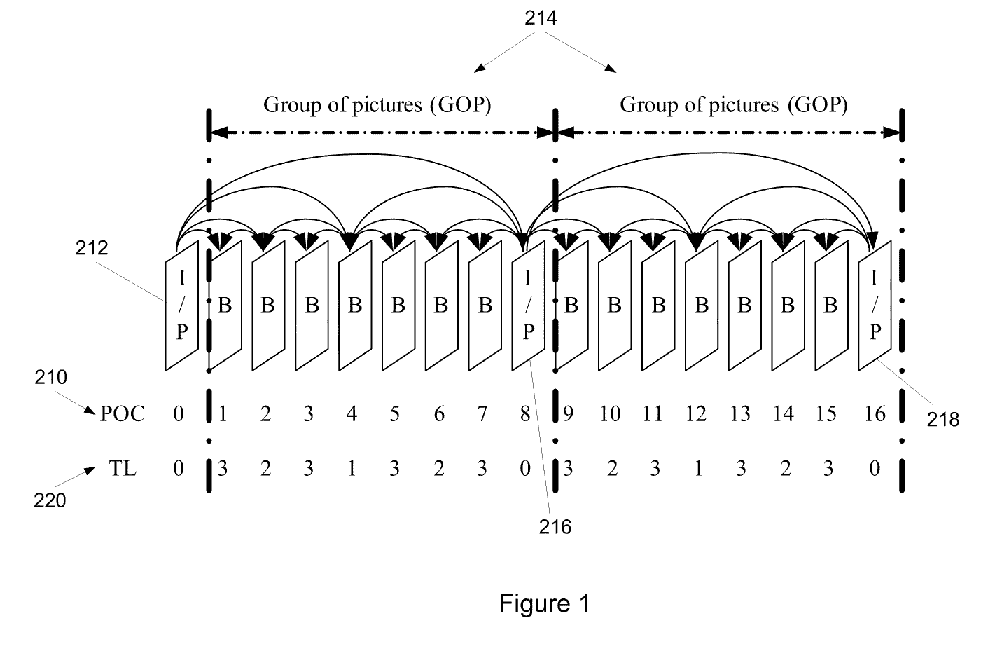

Referring now to FIG. 1, an exemplary hierarchical coding structure is illustrated with four levels of temporal scalability. The display order is indicated by the values denoted as picture order count (POC) 210. The I or P pictures, such as UP picture 212, also referred to as key pictures, are coded as the first picture of a group of pictures (GOPs) 214 in decoding order. When a key picture (e.g., key picture 216, 218) is inter-coded, the previous key pictures 212, 216 are used as reference for inter-picture prediction. These pictures correspond to the lowest temporal level 220 (denoted as TL in the figure) in the temporal scalable structure and are associated with the lowest frame rate. Pictures of a higher temporal level may only use pictures of the same or lower temporal level for inter-picture prediction. With such a hierarchical coding structure, different temporal scalability corresponding to different frame rates can be achieved by discarding pictures of a certain temporal level value and beyond. In FIG. 1, the pictures 0, 8 and 16 are of the lowest temporal level, while the pictures 1, 3, 5, 7, 9, 11, 13 and 15 are of the highest temporal level. Other pictures are assigned with other temporal level hierarchically. These pictures of different temporal levels compose the bitstream of different frame rate. When decoding all the temporal levels, a frame rate of 30 Hz is obtained. Other frame rates can be obtained by discarding pictures of some temporal levels. The pictures of the lowest temporal level are associated with the frame rate of 3.75 Hz. A temporal scalable layer with a lower temporal level or a lower frame rate is also called as a lower temporal layer.

The above-described hierarchical B picture coding structure is the most typical coding structure for temporal scalability. However, it is noted that much more flexible coding structures are possible. For example, the GOP size may not be constant over time. In another example, the temporal enhancement layer pictures do not have to be coded as B slices; they may also be coded as P slices.

In H.264/AVC, the temporal level may be signaled by the sub-sequence layer number in the sub-sequence information Supplemental Enhancement Information (SEI) messages. In SVC, the temporal level is signaled in the Network Abstraction Layer (NAL) unit header by the syntax element “temporal_id.” The bitrate and frame rate information for each temporal level is signaled in the scalability information SEI message.

A sub-sequence represents a number of inter-dependent pictures that can be disposed without affecting the decoding of the remaining bitstream. Pictures in a coded bitstream can be organized into sub-sequences in multiple ways. In most applications, a single structure of sub-sequences is sufficient.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this causes encoding-decoding mismatch, also referred to as drift, when some FGS data are discarded.

One important feature of SVC is that the FGS NAL units can be freely dropped or truncated, and MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_base_prediction_flag.” When the value of this element is equal to 1, decoding of the NAL unit uses the base representations of the reference pictures during the inter prediction process. The syntax element “store_base_rep_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_ref_active_{—}1x_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

The leaky prediction technique makes use of both base representations and decoded pictures (corresponding to the highest decoded “quality_id”), by predicting FGS data using a weighted combination of the base representations and decoded pictures. The weighting factor can be used to control the attenuation of the potential drift in the enhancement layer pictures. More information on leaky prediction can be found in H. C. Huang, C. N. Wang, and T. Chiang, “A robust fine granularity scalability using trellis-based predictive leak,” IEEE Trans. Circuits Syst. Video Technol., vol. 12, pp. 372-385, June 2002.

When leaky prediction is used, the FGS feature of the SVC is often referred to as Adaptive Reference FGS (AR-FGS). AR-FGS is a tool to balance between coding efficiency and drift control. AR-FGS enables leaky prediction by slice level signaling and MB level adaptation of weighting factors. More details of a mature version of AR-FGS can be found in JVT-W119: Yiliang Bao, Marta Karczewicz, Yan Ye “CE1 report: FGS simplification,” JVT-W119, 23^{rd} JVT meeting, San Jose, USA, April 2007, available at ftp3.itu.ch/av-arch/jvt-site/2007_{—}04_SanJose/JVT-W119.zip.

Random access refers to the ability of the decoder to start decoding a stream at a point other than the beginning of the stream and recover an exact or approximate representation of the decoded pictures. A random access point and a recovery point characterize a random access operation. The random access point is any coded picture where decoding can be initiated. All decoded pictures at or subsequent to a recovery point in output order are correct or approximately correct in content. If the random access point is the same as the recovery point, the random access operation is instantaneous; otherwise, it is gradual.

Random access points enable seek, fast forward, and fast backward operations in locally stored video streams. In video on-demand streaming, servers can respond to seek requests by transmitting data starting from the random access point that is closest to the requested destination of the seek operation. Switching between coded streams of different bit-rates is a method that is used commonly in unicast streaming for the Internet to match the transmitted bitrate to the expected network throughput and to avoid congestion in the network. Switching to another stream is possible at a random access point. Furthermore, random access points enable tuning in to a broadcast or multicast. In addition, a random access point can be coded as a response to a scene cut in the source sequence or as a response to an intra picture update request.

Conventionally each intra picture has been a random access point in a coded sequence. The introduction of multiple reference pictures for inter prediction caused that an intra picture may not be sufficient for random access. For example, a decoded picture before an intra picture in decoding order may be used as a reference picture for inter prediction after the intra picture in decoding order. Therefore, an IDR picture as specified in the H.264/AVC standard or an intra picture having similar properties to an IDR picture has to be used as a random access point. A closed group of pictures (GOP) is such a group of pictures in which all pictures can be correctly decoded. In H.264/AVC, a closed GOP starts from an IDR access unit (or from an intra coded picture with a memory management control operation marking all prior reference pictures as unused).

An open group of pictures (GOP) is such a group of pictures in which pictures preceding the initial intra picture in output order may not be correctly decodable but pictures following the initial intra picture are correctly decodable. An H.264/AVC decoder can recognize an intra picture starting an open GOP from the recovery point SEI message in the H.264/AVC bitstream. The pictures preceding the initial intra picture starting an open GOP are referred to as leading pictures. There are two types of leading pictures: decodable and non-decodable. Decodable leading pictures are such that can be correctly decoded when the decoding is started from the initial intra picture starting the open GOP. In other words, decodable leading pictures use only the initial intra picture or subsequent pictures in decoding order as reference in inter prediction. Non-decodable leading pictures are such that cannot be correctly decoded when the decoding is started from the initial intra picture starting the open GOP. In other words, non-decodable leading pictures use pictures prior, in decoding order, to the initial intra picture starting the open GOP as references in inter prediction. The draft amendment 1 of the ISO Base Media File Format (Edition 3) includes support for indicating decodable and non-decodable leading pictures.

It is noted that term GOP is used differently in the context of random access than in the context of SVC. In SVC, a GOP refers to the group of pictures from a picture having temporal_id equal to 0, inclusive, to the next picture having temporal_id equal to 0, exclusive. In the random access context, a GOP is a group of pictures that can be decoded regardless of the fact whether any earlier pictures in decoding order have been decoded.

Gradual decoding refresh (GDR) refers to the ability to start the decoding at a non-IDR picture and recover decoded pictures that are correct in content after decoding a certain amount of pictures. That is, GDR can be used to achieve random access from non-intra pictures. Some reference pictures for inter prediction may not be available between the random access point and the recovery point, and therefore some parts of decoded pictures in the gradual decoding refresh period cannot be reconstructed correctly. However, these parts are not used for prediction at or after the recovery point, which results into error-free decoded pictures starting from the recovery point.

It is obvious that gradual decoding refresh is more cumbersome both for encoders and decoders compared to instantaneous decoding refresh. However, gradual decoding refresh may be desirable in error-prone environments thanks to two facts: First, a coded intra picture is generally considerably larger than a coded non-intra picture. This makes intra pictures more susceptible to errors than non-intra pictures, and the errors are likely to propagate in time until the corrupted macroblock locations are intra-coded. Second, intra-coded macroblocks are used in error-prone environments to stop error propagation. Thus, it makes sense to combine the intra macroblock coding for random access and for error propagation prevention, for example, in video conferencing and broadcast video applications that operate on error-prone transmission channels. This conclusion is utilized in gradual decoding refresh.

Gradual decoding refresh can be realized with the isolated region coding method. An isolated region in a picture can contain any macroblock locations, and a picture can contain zero or more isolated regions that do not overlap. A leftover region is the area of the picture that is not covered by any isolated region of a picture. When coding an isolated region, in-picture prediction is disabled across its boundaries. A leftover region may be predicted from isolated regions of the same picture.

A coded isolated region can be decoded without the presence of any other isolated or leftover region of the same coded picture. It may be necessary to decode all isolated regions of a picture before the leftover region. An isolated region or a leftover region contains at least one slice.

Pictures, whose isolated regions are predicted from each other, are grouped into an isolated-region picture group. An isolated region can be inter-predicted from the corresponding isolated region in other pictures within the same isolated-region picture group, whereas inter prediction from other isolated regions or outside the isolated-region picture group is disallowed. A leftover region may be inter-predicted from any isolated region. The shape, location, and size of coupled isolated regions may evolve from picture to picture in an isolated-region picture group.

An evolving isolated region can be used to provide gradual decoding refresh. A new evolving isolated region is established in the picture at the random access point, and the macroblocks in the isolated region are intra-coded. The shape, size, and location of the isolated region evolve from picture to picture. The isolated region can be inter-predicted from the corresponding isolated region in earlier pictures in the gradual decoding refresh period. When the isolated region covers the whole picture area, a picture completely correct in content is obtained when decoding started from the random access point. This process can also be generalized to include more than one evolving isolated region that eventually cover the entire picture area.

There may be tailored in-band signaling, such as the recovery point SEI message, to indicate the gradual random access point and the recovery point for the decoder. Furthermore, the recovery point SEI message includes an indication whether an evolving isolated region is used between the random access point and the recovery point to provide gradual decoding refresh.

RTP is used for transmitting continuous media data, such as coded audio and video streams in Internet Protocol (IP) based networks. The Real-time Transport Control Protocol (RTCP) is a companion of RTP, i.e., RTCP should be used to complement RTP, when the network and application infrastructure allow its use. RTP and RTCP are usually conveyed over the User Datagram Protocol (UDP), which, in turn, is conveyed over the Internet Protocol (IP). RTCP is used to monitor the quality of service provided by the network and to convey information about the participants in an ongoing session. RTP and RTCP are designed for sessions that range from one-to-one communication to large multicast groups of thousands of end-points. In order to control the total bitrate caused by RTCP packets in a multiparty session, the transmission interval of RTCP packets transmitted by a single end-point is proportional to the number of participants in the session. Each media coding format has a specific RTP payload format, which specifies how media data is structured in the payload of an RTP packet.

Available media file format standards include ISO base media file format (ISO/IEC 14496-12), MPEG-4 file format (ISO/IEC 14496-14, also known as the MP4 format), AVC file format (ISO/IEC 14496-15), 3GPP file format (3GPP TS 26.244, also known as the 3GP format), and DVB file format. The ISO file format is the base for derivation of all the above mentioned file formats (excluding the ISO file format itself). These file formats (including the ISO file format itself) are called the ISO family of file formats.

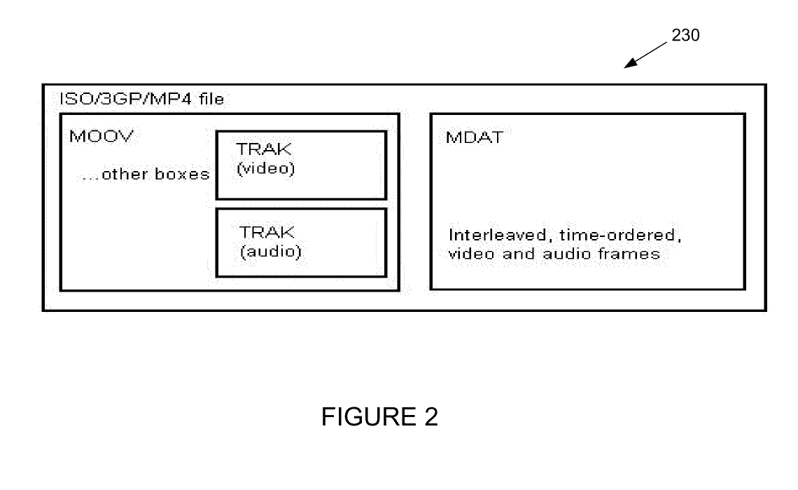

FIG. 2 shows a simplified file structure 230 according to the ISO base media file format. The basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, some boxes are mandatorily present in each file, while others are optional. Moreover, for some box types, it is allowed to have more than one box present in a file. It may be concluded that the ISO base media file format specifies a hierarchical structure of boxes.

According to ISO family of file formats, a file includes media data and metadata that are enclosed in separate boxes, the media data (mdat) box and the movie (moov) box, respectively. For a file to be operable, both of these boxes must be present. The movie box may contain one or more tracks, and each track resides in one track box. A track may be one of the following types: media, hint, timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced, i.e. it is indicated by a reference which piece of data in a particular track or item is instructed to be copied into a packet during the packet construction process. A timed metadata track refers to samples describing referred media and/or hint samples. For the presentation one media type, typically one media track is selected. Samples of a track are implicitly associated with sample numbers that are incremented by 1 in the indicated decoding order of samples.

The first sample in a track is associated with sample number 1. It is noted that this assumption affects some of the formulas below, and it is obvious for a person skilled in the art to modify the formulas accordingly for other start offsets of sample number (such as 0).

It is noted that the ISO base media file format does not limit a presentation to be contained in one file, but it may be contained in several files. One file contains the metadata for the whole presentation. This file may also contain all the media data, whereupon the presentation is self-contained. The other files, if used, are not required to be formatted to ISO base media file format, are used to contain media data, and may also contain unused media data, or other information. The ISO base media file format concerns the structure of the presentation file only. The format of the media-data files is constrained the ISO base media file format or its derivative formats only in that the media-data in the media files must be formatted as specified in the ISO base media file format or its derivative formats.

Movie fragments may be used when recording content to ISO files in order to avoid losing data if a recording application crashes, runs out of disk, or some other incident happens. Without movie fragments, data loss may occur because the file format insists that all metadata (the Movie Box) be written in one contiguous area of the file. Furthermore, when recording a file, there may not be sufficient amount of Random Access Memory (RAM) to buffer a Movie Box for the size of the storage available, and re-computing the contents of a Movie Box when the movie is closed is too slow. Moreover, movie fragments may enable simultaneous recording and playback of a file using a regular ISO file parser. Finally, smaller duration of initial buffering is required for progressive downloading, i.e. simultaneous reception and playback of a file, when movie fragments are used and the initial Movie Box is smaller compared to a file with the same media content but structured without movie fragments.

The movie fragment feature enables to split the metadata that conventionally would reside in the moov box to multiple pieces, each corresponding to a certain period of time for a track. In other words, the movie fragment feature enables to interleave file metadata and media data. Consequently, the size of the moov box may be limited and the use cases mentioned above be realized.

The media samples for the movie fragments reside in an mdat box, as usual, if they are in the same file as the moov box. For the meta data of the movie fragments, however, a moof box is provided. It comprises the information for a certain duration of playback time that would previously have been in the moov box. The moov box still represents a valid movie on its own, but in addition, it comprises an mvex box indicating that movie fragments will follow in the same file. The movie fragments extend the presentation that is associated to the moov box in time.

The metadata that may be included in the moof box is limited to a subset of the metadata that may be included in a moov box and is coded differently in some cases. Details of the boxes that may be included in a moof box may be found from the ISO base media file format specification.

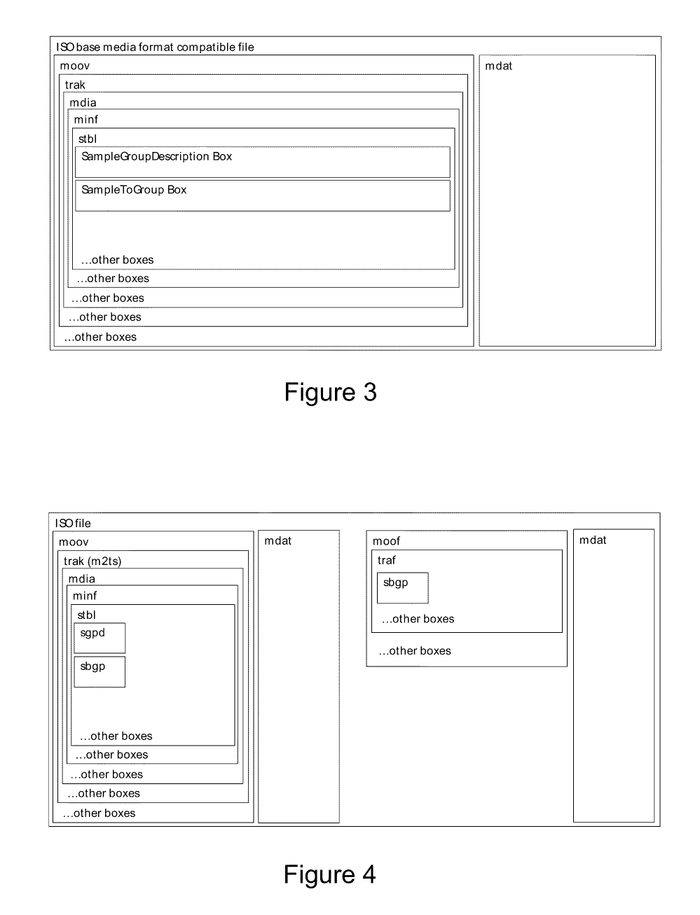

Referring now to FIGS. 3 and 4, the use of sample grouping in boxes is illustrated. A sample grouping in the ISO base media file format and its derivatives, such as the AVC file format and the SVC file format, is an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping has a type field to indicate the type of grouping. Sample groupings are represented by two linked data structures: (1) a SampleToGroup box (sbgp box) represents the assignment of samples to sample groups; and (2) a SampleGroupDescription box (sgpd box) contains a sample group entry for each sample group describing the properties of the group. There may be multiple instances of the SampleToGroup and SampleGroupDescription boxes based on different grouping criteria. These are distinguished by a type field used to indicate the type of grouping.

FIG. 3 provides a simplified box hierarchy indicating the nesting structure for the sample group boxes. The sample group boxes (SampleGroupDescription Box and SampleToGroup Box) reside within the sample table (stbl) box, which is enclosed in the media information (minf), media (mdia), and track (trak) boxes (in that order) within a movie (moov) box.

The SampleToGroup box is allowed to reside in a movie fragment. Hence, sample grouping may be done fragment by fragment. FIG. 4 illustrates an example of a file containing a movie fragment including a SampleToGroup box.

Error correction refers to the capability to recover erroneous data perfectly as if no errors were ever present in the received bitstream. Error concealment refers to the capability to conceal degradations caused by transmission errors so that they become hardly perceivable in the reconstructed media signal.

Forward error correction (FEC) refers to those techniques in which the transmitter adds redundancy, often known as parity or repair symbols, to the transmitted data, enabling the receiver to recover the transmitted data even if there were transmission errors. In systematic FEC codes, the original bitstream appears as such in encoded symbols, while encoding with non-systematic codes does not re-create the original bitstream as output. Methods in which additional redundancy provides means for approximating the lost content are classified as forward error concealment techniques.

Forward error control methods that operate below the source coding layer are typically codec- or media-unaware, i.e. the redundancy is such that it does not require parsing the syntax or decoding of the coded media. In media-unaware forward error control, error correction codes, such as Reed-Solomon codes, are used to modify the source signal in the sender side such that the transmitted signal becomes robust (i.e. the receives can recover the source signal even if some errors hit the transmitted signal). If the transmitted signal contains the source signal as such, the error correction code is systematic, and otherwise it is non-systematic.

Media-unaware forward error control methods are typically characterized by the following factors:
k=number of elements (typically bytes or packets) in a block over which the code is calculated;
n=number of elements that are sent;
n−k is therefore the overhead that the error correcting code brings;
k′=required number of elements that needs to be received to reconstruct the source block provided that there are no transmission errors; and
t=number of erased elements the code can recover (per block)

Media-unaware error control methods can also be applied in an adaptive way (which can also be media-aware) such that only a part of the source samples is processed with error correcting codes. For example, non-reference pictures of a video bitstream may not be protected, as any transmission error hitting a non-reference picture does not propagate to other pictures.

Redundant representations of a media-aware forward error control method and the n−k′ elements that are not needed to reconstruct a source block in a media-unaware forward error control method are collectively referred to as forward error control overhead in this document.

The invention is applicable in receivers when the transmission is time-sliced or when FEC coding has been applied over multiple access units. Hence, two systems are introduced in this section: Digital Video Broadcasting-Handheld (DVB-H) and 3GPP Multimedia Broadcast/Multicast Service (MBMS).

DVB-H is based on and compatible with DVB-Terrestrial (DVB-T). The extensions in DVB-H relative to DVB-T make it possible to receive broadcast services in handheld devices.

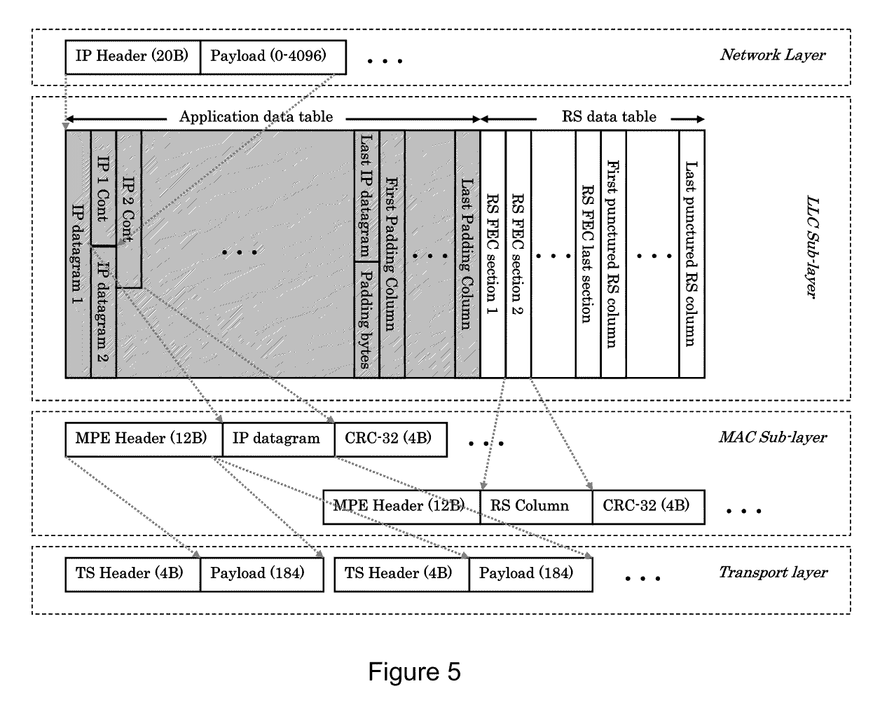

The protocol stack for DVB-H is presented in FIG. 5. IP packets are encapsulated to Multi-Protocol Encapsulation (MPE) sections for transmission over the Medium Access (MAC) sub-layer. Each MPE section includes a header, the IP datagram as a payload, and a 32-byte cyclic redundancy check (CRC) for the verification of payload integrity. The MPE section header contains addressing data among other things. The MPE sections can be logically arranged to application data tables in the Logical Link Control (LLC) sub-layer, over which Reed-Solomon (RS) FEC codes are calculated and MPE-FEC sections are formed. The process for MPE-FEC construction is explained in more detail below. The MPE and MPE-FEC sections are mapped onto MPEG-2 Transport Stream (TS) packets.

MPE-FEC was included in DVB-H to combat long burst errors that cannot be efficiently corrected in the physical layer. As Reed-Solomon code is a systematic code (i.e., the source data remains unchanged in the FEC encoding) MPE-FEC decoding is optional for DVB-H terminals. MPE-FEC repair data is computed over IP packets and encapsulated into MPE-FEC sections, which are transmitted such a way that an MPE-FEC ignorant receiver could just receive just the unprotected data while ignoring the repair data that follows.

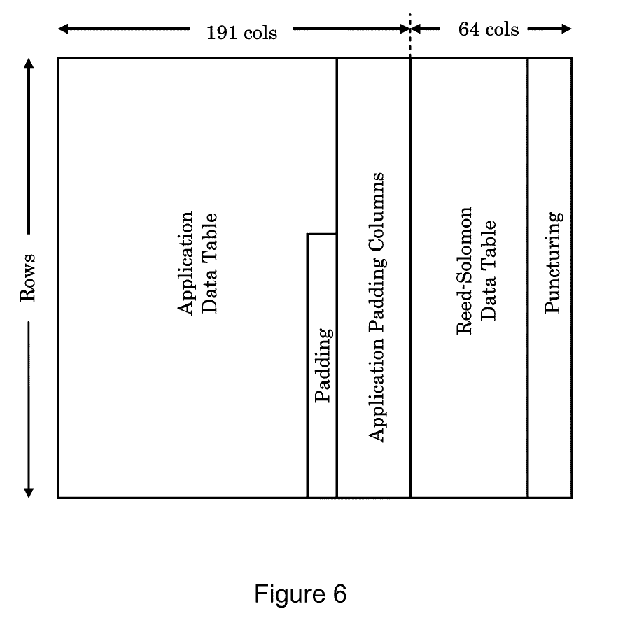

To compute MPE-FEC repair data, IP packets are filled column-wise into an N×191 matrix where each cell of the matrix hosts one byte and N denotes the number of rows in the matrix. The standard defines the value of N to be one of 256, 512, 768 or 1024. RS codes are computed for each row and concatenated such that the final size of the matrix is of size N×255. The N×191 part of the matrix is called the Application data table (ADT) and the next N×64 part of the matrix is called the RS data table (RSDT). The ADT need not be completely filled, which must be used to avoid IP packet fragmentation between two MPE-FEC frames and may also be exploited to control bitrate and error protection strength. The unfilled part of the ADT is called padding. To control the strength of the FEC protection, all 64 columns of RSDT need not be transmitted, i.e., the RSDT may be punctured. The structure of an MPE-FEC frame is illustrated in FIG. 6.

Mobile devices have a limited source of power. The power consumed in receiving, decoding and demodulating a standard full-bandwidth DVB-T signal would use a substantial amount of battery life in a short time. Time slicing of the MPE-FEC frames is used to solve this problem. The data is received in bursts so that the receiver, utilizing control signals, remains inactive when no bursts are to be received. A burst is sent at a significantly higher bitrate compared to bitrate of the media streams carried in the burst.

MBMS can be functionally split into the bearer service and the user service. The MBMS bearer service specifies the transmission procedures below the IP layer, whereas the MBMS user service specifies the protocols and procedures above the IP layer. The MBMS user service includes two delivery methods: download and streaming. This section provides a brief overview of the MBMS streaming delivery method.

The streaming delivery method of MBMS uses a protocol stack based on RTP. Due to the broadcast/multicast nature of the service, interactive error control features, such as retransmissions, are not used. Instead, MBMS includes an application-layer FEC scheme for streamed media. The scheme is based on an FEC RTP payload format that has two packet types, FEC source packets and FEC repair packets. FEC source packets contain media data according to the media RTP payload format followed by the source FEC payload ID field. FEC repair packets contain the repair FEC payload ID and FEC encoding symbols (i.e., repair data). The FEC payload IDs indicate which FEC source block the payload is associated with and the position of the header and the payload of the packet in the FEC source block. FEC source blocks contain entries, each of which has a one-byte flow identifier, two-byte length of the following UDP payload, and an UDP payload, i.e., RTP packet including the RTP header but excluding any underlying packet headers. The flow identifier, which is unique for each pair of destination UDP port number and destination IP address, enables the protection of multiple RTP streams with the same FEC coding. This enables larger FEC source blocks compared to FEC source blocks composed of single RTP stream under the same period of time and hence may improve error robustness. However, a receiver must receive all the bundled flows (i.e., RTP streams), even if only a subset of the flows belongs to the same multimedia service.

The processing in the sender can be outlined as follows: An original media RTP packet, generated by the media encoder and encapsulator, is modified to indicate RTP payload type of the FEC payload and appended with the source FEC payload ID. The modified RTP packet is sent using the normal RTP mechanisms. The original media RTP packet is also copied into the FEC source block. Once the FEC source block is filled up with RTP packets, the FEC encoding algorithm is applied to calculate a number of FEC repair packets that are also sent using the normal RTP mechanisms. Systematic Raptor codes are used as the FEC encoding algorithm of MBMS.

At the receiver, all FEC source packets and FEC repair packets associated with the same FEC source block are collected and the FEC source block is reconstructed. If there are missing FEC source packets, FEC decoding can be applied based the FEC repair packets and the FEC source block. FEC decoding leads to the reconstruction of any missing FEC source packets, when the recovery capability of the received FEC repair packet is sufficient. The media packets that were received or recovered are then handled normally by the media payload decapsulator and decoder.

Adaptive media playout refers to adapting the rate of the media playout from its capturing rate and therefore intended playout rate. In the literature, adaptive media playout is primarily used to smooth out transmission delay jitter in low-delay conversational applications (voice over IP, video telephone, and multiparty voice/video conferencing) and to adjust the clock drift between the originator and playing device. In streaming and television-like broadcasting applications, initial buffering is used to smooth out potential delay jitter and hence adaptive media playout is not used for those purposes (but may still be used for clock drift adjustment). Audio time-scale modification (see below) has also been used in watermarking, data embedding, and video browsing in the literature.

Real-time media content (typically audio and video) can be classified as continuous or semi-continuous. Continuous media continuously and actively changes, examples being music and the video stream for television programs or movies. Semi-continuous media are characterized by inactivity periods. Spoken voice with silence detection is a widely used semi-continuous medium. From adaptive media playout point of view, the main difference between these two media content types is that the duration of the inactivity periods of semi-continuous media can be adjusted easily. Instead, continuous audio signal has to be modified in an imperceptible manner e.g. by sampling various time-scale modification methods. One reference of adaptive audio playout algorithms for both continuous and semi-continuous audio is Y. J. Liang, N. Färber, and B. Girod, “Adaptive playout scheduling using time-scale modification in packet voice communications,” Proceedings of IEEE International Conference on Acoustics, Speech, and Signal Processing, vol. 3, pp. 1445-1448, May 2001. Various methods for time-scale modification of continuous audio signal can be found from the literature. According to [J. Laroche, “Autocorrelation method for high-quality time/pitch-scaling,” Proceedings of IEEE Workshop on Applications of Signal Processing to Audio and Acoustics, pp. 131-134, Oct. 1993.], up to 15% time-scale modification was found to generate virtually no audible artifacts. It is noted that adaptive playout of video is non-problematic, as decoded video pictures are usually paced according to the audio playout clock.

It has been noticed that adaptive media playout is not only needed for smoothing out the transmission delay jitter but it also needs to be optimized together with the forward error correction scheme in use. In other words, the inherent delay of receiving all data for an FEC block has to be considered when determining the playout scheduling of media. One of the first papers about the topic is J. Rosenberg, Q. Lili, and H. Schulzrinne, “Integrating packet FEC into adaptive voice playout buffer algorithms on the Internet,” Proceedings of the IEEE Computer and Communications Societies Conference (INFOCOM), vol. 3, pp. 1705-1714, March 2000. To our knowledge, adaptive media playout algorithms which are jointly designed for FEC block reception delay and transmission delay jitter have been considered only for the conversational applications in the scientific literature.

Multi-level temporal scalability hierarchies enabled by H.264/AVC and SVC are suggested to be used due to their significant compression efficiency improvement. However, the multi-level hierarchies also cause a significant delay between starting of the decoding and starting of the rendering. The delay is caused by the fact that decoded pictures have to be reordered from their decoding order to the output/display order. Consequently, when accessing a stream from a random position, the start-up delay is increased, and similarly the tune-in delay to a multicast or broadcast is increased compared to those of non-hierarchical temporal scalability.

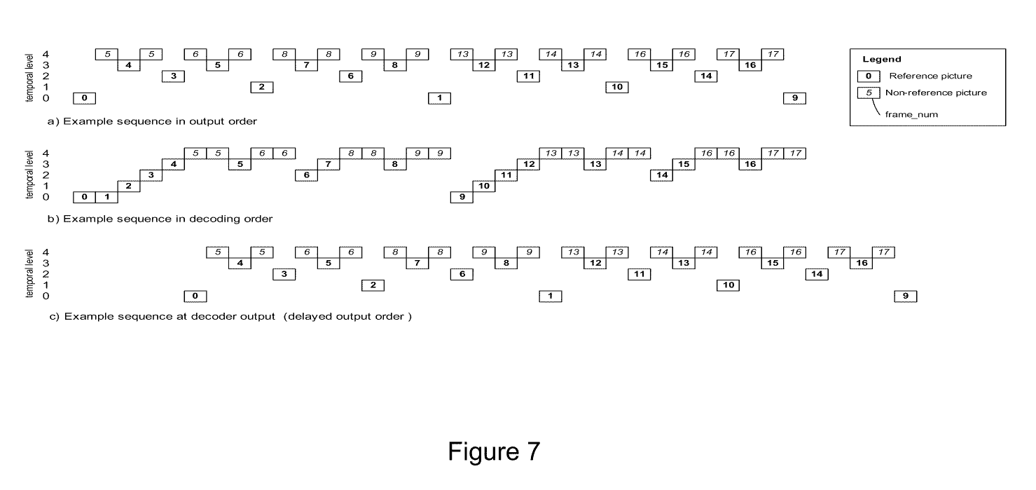

FIGS. 7(a)-(c) illustrate a typical hierarchically scalable bitstream with five temporal levels (a.k.a. GOP size 16). Pictures at temporal level 0 are predicted from the previous picture(s) at temporal level 0. Pictures at temporal level N (N>0) are predicted from the previous and subsequent pictures in output order at temporal level <N. It is assumed in this example that decoding of one picture lasts one picture interval. Even though this is a naïve assumption, it serves the purpose of illustrating the problem without loss of generality.

FIG. 7a shows the example sequence in output order. Values enclosed in boxes indicate the frame_num value of the picture. Values in italics indicate a non-reference picture while the other pictures are reference pictures.

FIG. 7b shows the example sequence in decoding order. FIG. 7c shows the example sequence in output order when assuming that the output timeline coincides with that of the decoding timeline. In other words, in FIG. 7c the earliest output time of a picture is in the next picture interval following the decoding of the picture. It can be seen that playback of the stream starts five picture intervals later than the decoding of the stream started. If the pictures were sampled at 25 Hz, the picture interval is 40 msec, and the playback is delayed by 0.2 sec.

Hierarchical temporal scalability applied in modem video coding (H.264/AVC and SVC) improves compression efficiency but increases the decoding delay due to reordering of the decoded pictures from the (de)coding order to output order. It is possible to omit decoding of so-called sub-sequences in hierarchical temporal scalability. According to embodiments of the present invention, decoding or transmission of selected sub-sequences is omitted when decoding or transmission is started: after random access, at the beginning of the stream, or when tuning in to a broadcast/multicast. Consequently, the delay for reordering these selected decoded pictures into their output order is avoided and the startup delay is reduced. Therefore, embodiments of the present invention may improve the response time (and hence the user experience) when accessing video streams or switching channels of a broadcast.

Embodiments of the present invention are applicable in players where access to the start of the bitstream is faster than the natural decoding rate of the bitstream that results into playback at normal rate. Examples of such players are stream playback from a mass memory, reception of time-division-multiplexed bursty transmission (such as DVB-H mobile television), and reception of streams where forward error correction (FEC) has been applied over several media frames and FEC decoding is performed (e.g. MBMS receiver). Players choose which sub-sequences of the bitstream are not decoded.

Embodiments of the present invention can also be applied by servers or senders for unicast delivery. The sender chooses which sub-sequences of the bitstream are transmitted to the receiver when the receiver starts the reception of the bitstream or accesses the bitstream from a desired position.

Embodiments of the present invention can also be applied by file generators that create instructions for accessing a multimedia file from a selected random access positions. The instructions can be applied in local playback or when encapsulating the bitstream for unicast delivery.

Embodiments of the present invention can also be applied when a receiver joins a multicast or a broadcast. As a response to joining a multicast or a broadcast, a receiver may get instructions over unicast delivery about which sub-sequences should be decoded for accelerated startup. In some embodiments, instructions relating to which sub-sequences should be decoded for accelerated startup may be included in the multicast or broadcast streams.

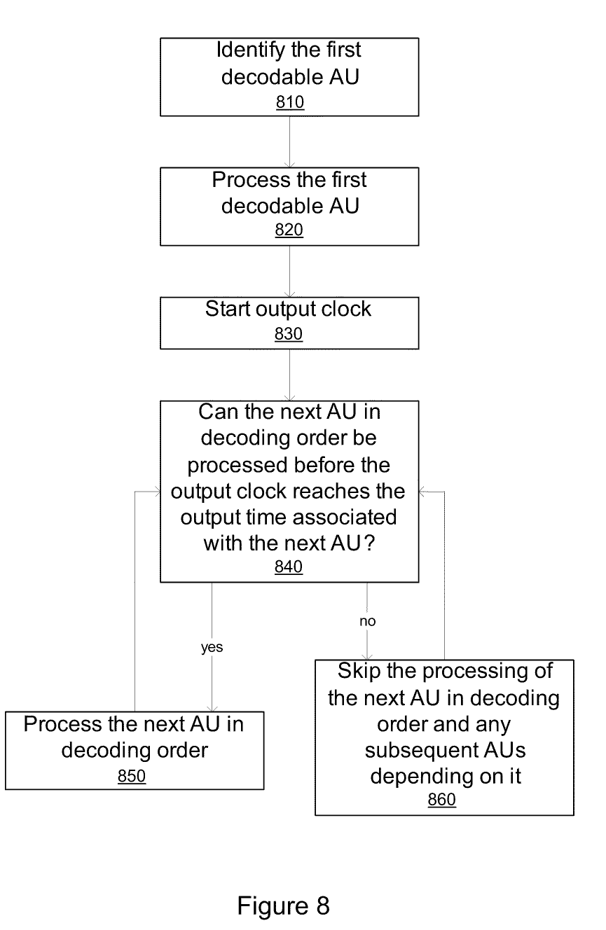

Referring now to FIG. 8, an example implementation of an embodiment of the present invention is illustrated. At block 810, the first decodable access unit is identified among those access units that the processing unit has access to. A decodable access unit can be defined, for example, in one or more of the following ways:
An IDR access unit;
An SVC access unit with an IDR dependency representation for which the dependency_id is smaller than the greatest dependency_id of the access unit;
An MVC access unit containing an anchor picture;
An access unit including a recovery point SEI message, i.e., an access unit starting an open GOP (when recovery_frame_cnt is equal to 0) or a gradual decoding refresh period (when recovery_frame_cnt is greater than 0);
An access unit containing a redundant IDR picture;
An access unit containing a redundant coded picture associated with a recovery point SEI message.

In the broadest sense, a decodable access unit may be any access unit. Then, prediction references that are missing in the decoding process are ignored or replaced by default values, for example.

The access units among which the first decodable access unit is identified depends on the functional block where the invention is implemented. If the invention is applied in a player accessing a bitstream from a mass memory or in a sender, the first decodable access unit can be any access unit starting from the desired access position or it may be the first decodable access unit preceding or at the desired access position. If the invention is applied in a player accessing a received bitstream, the first decodable access unit is one of those in the first received data burst or FEC source matrix.

The first decodable access unit can be identified by multiple means including the following:
Indication in the video bitstream, such as nal_unit_type equal to 5, idr_flag equal to 1, or recovery point SEI message present in the bitstream.
Indicated by the transport protocol, such as the A bit of the PACSI NAL unit of the SVC RTP payload format. The A bit indicates whether CGS or spatial layer switching at a non-IDR layer representation (a layer representation with nal_unit_type not equal to 5 and idr_flag not equal to 1) can be performed. With some picture coding structures a non-IDR intra layer representation can be used for random access. Compared to using only IDR layer representations, higher coding efficiency can be achieved. The H.264/AVC or SVC solution to indicate the random accessibility of a non-IDR intra layer representation is using a recovery point SEI message. The A bit offers direct access to this information, without having to parse the recovery point SEI message, which may be buried deeply in an SEI NAL unit. Furthermore, the SEI message may not be present in the bitstream.
Indicated in the container file. For example, the Sync Sample Box, the Shadow Sync Sample Box, the Random Access Recovery Point sample grouping, the Track Fragment Random Access Box can be used in files compatible with the ISO Base Media File Format.
Indicated in the packetized elementary stream.

Referring again to FIG. 8, at block 820, the first decodable access unit is processed. The method of processing depends on the functional block where the example process of FIG. 8 is implemented. If the process is implemented in a player, processing comprises decoding. If the process is implemented in a sender, processing may comprise encapsulating the access unit into one or more transport packets and transmitting the access unit as well as (potentially hypothetical) receiving and decoding of the transport packets for the access unit. If the process is implemented in a file creator, processing comprises writing (into a file, for example) instructions which sub-sequences should be decoded or transmitted in an accelerated startup procedure.

At block 830, the output clock is initialized and started. Additional operations simultaneous to the starting of the output clock may depend on the functional block where the process is implemented. If the process is implemented in a player, the decoded picture resulting from the decoding of the first decodable access unit can be displayed simultaneously to the starting of the output clock. If the process is implemented in a sender, the (hypothetical) decoded picture resulting from the decoding of the first decodable access unit can be (hypothetically) displayed simultaneously to the starting of the output clock. If the process is implemented in a file creator, the output clock may not represent a wall clock ticking in real-time but rather it can be synchronized with the decoding or composition times of the access units.

In various embodiments, the order of the operation of blocks 820 and 830 may be reversed.

At block 840, a determination is made as to whether the next access unit in decoding order can be processed before the output clock reaches the output time of the next access unit. The method of processing depends on the functional block where the process is implemented. If the process is implemented in a player, processing comprises decoding. If the process is implemented in a sender, processing typically comprises encapsulating the access unit into one or more transport packets and transmitting the access unit as well as (potentially hypothetical) receiving and decoding of the transport packets for the access unit. If the process is implemented in a file creator, processing is defined as above for the player or the sender depending on whether the instructions are created for a player or a sender, respectively.

It is noted that if the process is implemented in a sender or in a file creator that creates instructions for bitstream transmission, the decoding order may be replaced by a transmission order which need not be the same as the decoding order.

In another embodiment, the output clock and processing are interpreted differently when the process is implemented in a sender or a file creator that creates instructions for transmission. In this embodiment, the output clock is regarded as the transmission clock. At block 840, it is determined whether the scheduled decoding time of the access unit appears before the output time (i.e., the transmission time) of the access unit. The underlying principle is that an access unit should be transmitted or instructed to be transmitted (e.g., within a file) before its decoding time. Term processing comprises encapsulating the access unit into one or more transport packets and transmitting the access unit—which, in the case of file creator, are hypothetical operations that the sender would do when following the instructions given in the file.

If the determination is made at block 840 that the next access unit in decoding order can be processed before the output clock reaches the output time associated with the next access unit, the process proceeds to block 850. At block 850, the next access unit is processed. Processing is defined the same way as in block 820. After the processing at block 850, the pointer to the next access unit in decoding order is incremented by one access unit, and the procedure returns to block 840.

On the other hand, if the determination is made at block 840 that the next access unit in decoding order cannot be processed before the output clock reaches the output time associated with the next access unit, the process proceeds to block 860. At block 860, the processing of the next access unit in decoding order is omitted. In addition, the processing of the access units that depend on the next access unit in decoding is omitted. In other words, the sub-sequence having its root in the next access unit in decoding order is not processed. Then, the pointer to the next access unit in decoding order is incremented by one access unit (assuming that the omitted access units are no longer present in the decoding order), and the procedure returns to block 840.

The procedure is stopped at block 840 if there are no more access units in the bitstream.

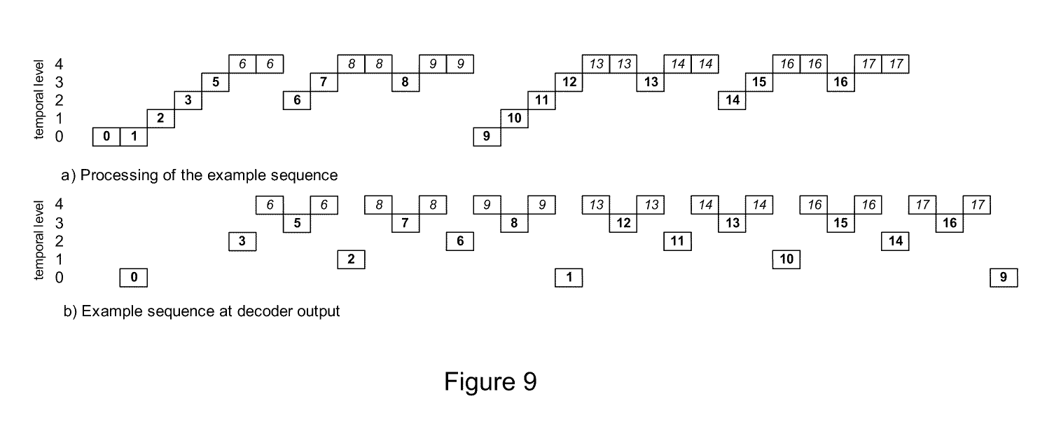

In the following, as an example, the process of FIG. 8 is illustrated as applied to the sequence of FIG. 7. In FIG. 9a, the access units selected for processing are illustrated. In FIG. 9b, the decoded pictures resulting from the decoding of the access units in FIG. 9a are presented. FIG. 9a and FIG. 9b are horizontally aligned such a way that the earliest timeslot a decoded picture can appear in the decoder output in FIG. 9b is the next timeslot relative to the processing timeslot of the respective access unit in FIG. 9a.

At block 810 of FIG. 8, the access unit with frame_num equal to 0 is identified as the first decodable access unit.

At block 820 of FIG. 8, the access unit with frame_num equal to 0 is processed.

At block 830 of FIG. 8, the output clock is started and the decoded picture resulting form the (hypothetical) decoding of the access unit with frame_num equal to 0 is (hypothetically) output.

Blocks 840 and 850 of FIG. 8 are iteratively repeated for access units with frame_num equal to 1, 2, and 3, because they can be processed before the output clock reaches their output time.

When the access unit with frame_num equal to 4 is the next one in decoding order, its output time has already passed. Thus, the access unit having frame_num equal to 4 and the access units containing non-reference pictures with frame_num equal to 5 are skipped (block 860 of FIG. 8).

Blocks 840 and 850 of FIG. 8 are then iteratively repeated for all the subsequent access units in decoding order, because they can be processed before the output clock reaches their output time.

In this example, the rendering of pictures starts four picture intervals earlier when the procedure of FIG. 8 is applied compared to the conventional approach previously described. When the picture rate is 25 Hz, the saving in startup delay is 160 msec. The saving in the startup delay comes with the disadvantage of a longer picture interval at the beginning of the bitstream.

In an alternative implementation, more than one frame are processed before the output clock is started. The output clock may not be started from the output time of the first decoded access unit but a later access unit may be selected. Correspondingly, the selected later frame is transmitted or played simultaneously when the output clock is started.

In one embodiment, an access unit may not be selected for processing even if it could be processed before its output time. This is particularly the case if the decoding of multiple consecutive sub-sequences in the same temporal levels is omitted.

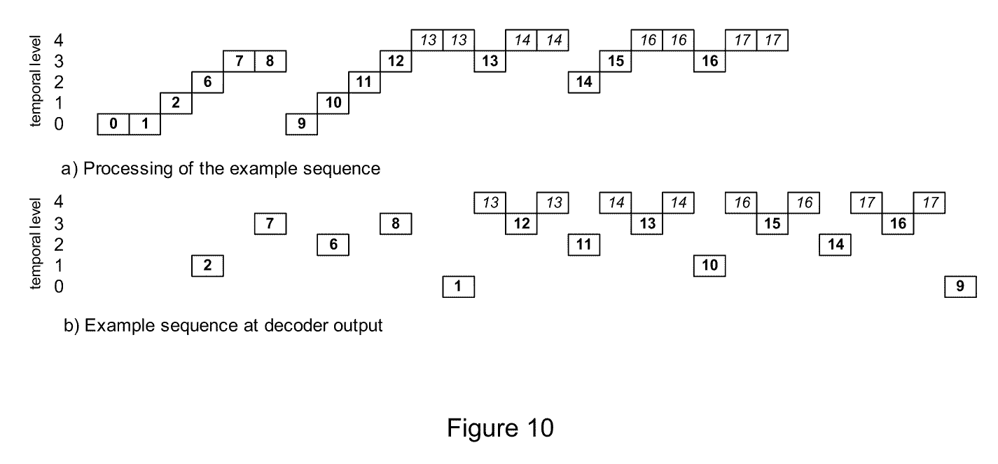

FIG. 10 illustrates another example sequence in accordance with embodiments of the present invention. In this example, the decoded picture resulting from access unit with frame_num equal to 2 is the first one that is output/transmitted. The decoding of sub-sequence containing access units that depend on the access unit with frame_num equal to 3 is omitted and the decoding of non-reference pictures within the second half of the first GOP is omitted too. As a result, the output picture rate of the first GOP is half of normal picture rate, but the display process starts two frame intervals (80 msec in 25 Hz picture rate) earlier than in the conventional solution previously described.

When the processing of a bitstream starts from the intra picture starting an open GOP, the processing of non-decodable leading pictures is omitted. In addition, the processing of decodable leading pictures can be omitted too. In addition, one or more sub-sequences occurring after, in output order, the intra picture starting the open GOP are omitted.

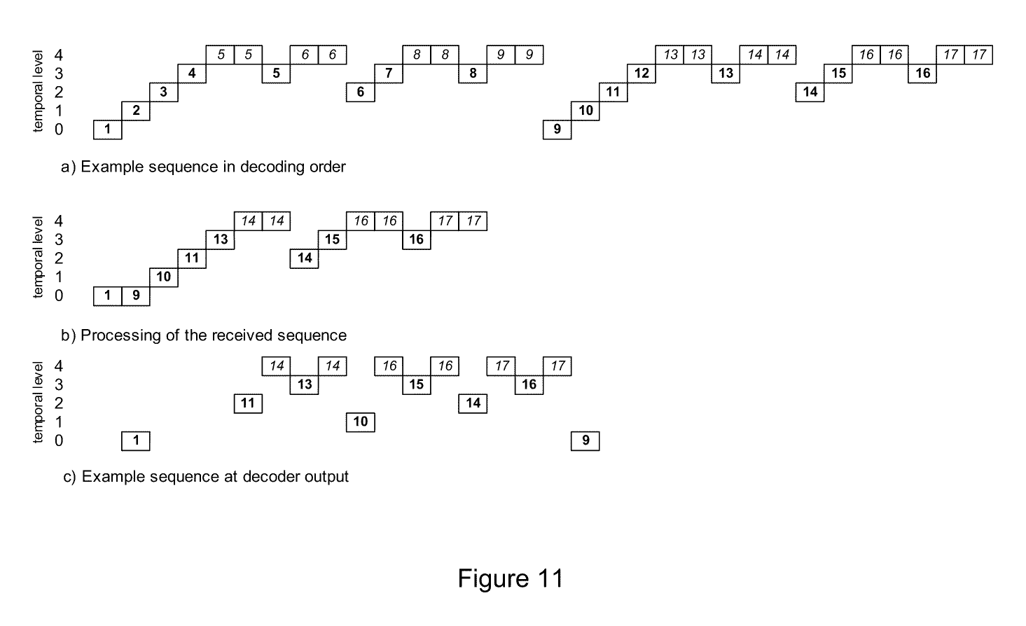

FIG. 11a presents an example sequence whose first access unit in decoding order contains an intra picture starting an open GOP. The frame_num for this picture is selected to be equal to 1 (but any other value of frame_num would have been equally valid provided that the subsequent values of frame_num had been changed accordingly). The sequence in FIG. 11a is the same as in FIG. 7a but the initial IDR access unit is not present (e.g., is not received since reception started subsequently to the transmission of the initial IDR access unit). The decoded pictures with frame_num from 2 to 8, inclusive, and the decoded non-reference pictures with frame_num equal to 9 occur therefore before the decoded picture with frame_num equal to 1 in output order and are non-decodable leading pictures. The decoding of them is therefore omitted as can be observed from FIG. 11b. In addition, the procedure presented above with reference to FIG. 8 is applied for the remaining access units. As a result, the processing of access units with frame_num equal to 12 and the access units containing non-reference pictures with frame_num equal to 13 is omitted. The processed access units are FIG. 11b and the resulting picture sequence at decoder output is presented in FIG. 11c. In this example, the decoded picture output is started 19 picture intervals (i.e., 760 msec at 25 Hz picture rate) earlier than with a conventional implementation.

If earliest decoded picture in output order is not output (e.g. as a result of processing similar to what is illustrated in FIG. 10 and FIGS. 11a-c), additional operations may have to be performed depending on the functional block where the embodiments of the invention are implemented.
If an embodiment of the invention is implemented in a player that receives a video bitstream and one or more bitstreams synchronized with the video bitstream in real-time (i.e., on average not faster than the decoding or playback rate), the processing of some of the first access units of the other bitstreams may have to be omitted in order to have synchronous playout of all the streams and the playback rate of the streams may have to be adapted (slowed down). If the playback rate were not adapted, the next received transmission burst or next decoded FEC source block might be available later than the last decoded samples of the first received transmission burst or first decoded FEC source block, i.e., there could be a gap or break in the playback. Any adaptive media playout algorithm can be used.
If an embodiment of the invention is implemented in a sender or a file creator that writes instructions for transmitting streams, the first access units from the bitstreams synchronized with the video bitstream are selected to match the first decoded picture in output time as closely as possible.

If an embodiment of the invention is applied to a sequence where the first decodable access unit contains the first picture of a gradual decoding refresh period, only access units with temporal_id equal to 0 are decoded. Furthermore, only the reliable isolated region may be decoded within the gradual decoding refresh period.

If the access units are coded with quality, spatial or other scalability means, only selected dependency representations and layer representations may be decoded in order to speed up the decoding process and further reduce the startup delay.

An example of an embodiment of the present invention realized with the ISO base media file format will now be described.

When accessing a track starting from a sync sample, the output of decoded pictures can be started earlier if certain sub-sequences are not decoded. In accordance with an embodiment of the present invention, the sample grouping mechanism may be used to indicate whether or not samples should be processed for accelerated decoded picture buffering (DPB) in random access. An alternative startup sequence contains a subset of samples of a track within a certain period starting from a sync sample. By processing this subset of samples, the output of processing the samples can be started earlier than in the case when all samples are processed. The ‘alst ’ sample group description entry indicates the number of samples in the alternative startup sequence, after which all samples should be processed. In the case of media tracks, processing includes parsing and decoding. In the case of hint tracks, processing includes forming the packets according to the instructions of in the hint samples and potentially transmitting the formed packets.

class AlternativeStartupEntry( ) extends VisualSampleGroupEntry
(’alst’)
{

unsigned int(16) roll_count;
unsigned int(16) first_output_sample;
for (i=1; i <= roll_count; i++)

unsigned int(32) sample_offset[i];

}

roll_count indicates the number of samples in the alternative startup sequence. If roll_count is equal to 0, the associated sample does not belong to any alternative startup sequence and the semantics of first_output_sample are unspecified. The number of samples mapped to this sample group entry per one alternative startup sequence shall be equal to roll_count.

first_output_sample indicates the index of the first sample intended for output among the samples in the alternative startup sequence. The index is of the sync sample starting the alternative startup sequence is 1, and the index is incremented by 1, in decoding order, per each sample in the alternative startup sequence.

sample_offset [i] indicates the decoding time delta of the i-th sample in the alternative startup sequence relative to the regular decoding time of the sample derived from the Decoding Time to Sample Box or the Track Fragment Header Box. The sync sample starting the alternative startup sequence is its first sample.

In another embodiment, sample_offset [i] is a signed composition time offset (relative to regular decoding time of the sample derived from the Decoding Time to Sample Box or the Track Fragment Header Box).

In another embodiment, the DVB Sample Grouping mechanism could be used and sample_offset[i] given as index_payload instead of providing sample_offset[i] in the sample group description entries. This solution might reduce the number of required sample group description entries.

In one embodiment, a file parser according to the invention accesses a track from a non-continuous location as follows. A sync sample from which to start processing is selected. The selected sync sample may be at the desired non-continuous location, be the closest preceding sync sample relative to the desired non-continuous location, or be the closest following sync sample relative to the desired non-continuous location. The samples within the alternative startup sequence are identified based on the respective sample group. The samples within the alternative startup sequence are processed. In the case of media tracks, processing includes decoding and potentially rendering. In the case of hint tracks, processing includes forming the packets according to the instructions of in the hint samples and potentially transmitting the formed packets. The timing of the processing may be modified as indicated by the sample_offset[i] values.

The indications discussed above (i.e., roll_count, first_output_sample, and sample_offset[i]) can be included in the bitstream, e.g. as SEI messages, in the packet payload structure, in the packet header structure, in the packetized elementary stream structure and in the file format or indicated by other means. The indications discussed in this section can be created by the encoder, by a unit that analyzes bitstream, or by a file creator, for example.

In one embodiment, a decoder according to the invention starts decoding from a decodable AU. The decoder receives information on an alternative startup sequence through an SEI message, for example. The decoder selects access units for decoding if they are indicated to belong to the alternative startup sequence and skips the decoding of those access units that are not in the alternative startup sequence (as long as the alternative startup sequence lasts). When the decoding of the alternative startup sequence has been completed, the decoder decodes all access units.

In order to assist a decoder, receiver or player to select which sub-sequences are omitted from decoding, indications of the temporal scalability structure of the bitstream can be provided. One example is a flag that indicates whether or not a regular “bifurcative” nesting structure as illustrated in FIG. 2 is used and how many temporal levels are present (or what is the GOP size). Another example of an indication is a sequence of temporal_id values, each indicating the temporal_id of the an access unit in decoding order. The temporal_id of the any picture can be concluded by repeating the indicated sequence of temporal_id values, i.e., the sequence of temporal_id values indicates the repetitive behavior of temporal_id values. A decoder, receiver, or player according to the invention selected the omitted and decoded sub-sequences based on the indication.

The intended first decoded picture for output can be indicated. This indication assists a decoder, receiver, or player to perform as expected by a sender or a file creator. For example, it can be indicated that the decoded picture with frame_num equal to 2 is the first one that is intended for output in the example of FIG. 10. Otherwise, the decoder, receiver, or player may output the decoded picture with frame_num equal to 0 first and the output process would not as intended by the sender or file creator and the saving in startup delay might not be optimal.

HRD parameters for starting the decoding from an associated first decodable access unit (rather than earlier, e.g., from the beginning of the bitstream) can be indicated. These HRD parameters indicate the initial CPB and DPB delays that are applicable when the decoding starts from the associated first decodable access unit.

Thus, in accordance with embodiments of the present invention, a reduction of tune-in/startup delay of decoding of temporally scalable video bitstreams by up to a few hundred milliseconds may be achieved. Temporally scalable video bitstreams may improve compression efficiency by at least 25% in terms of bitrate.

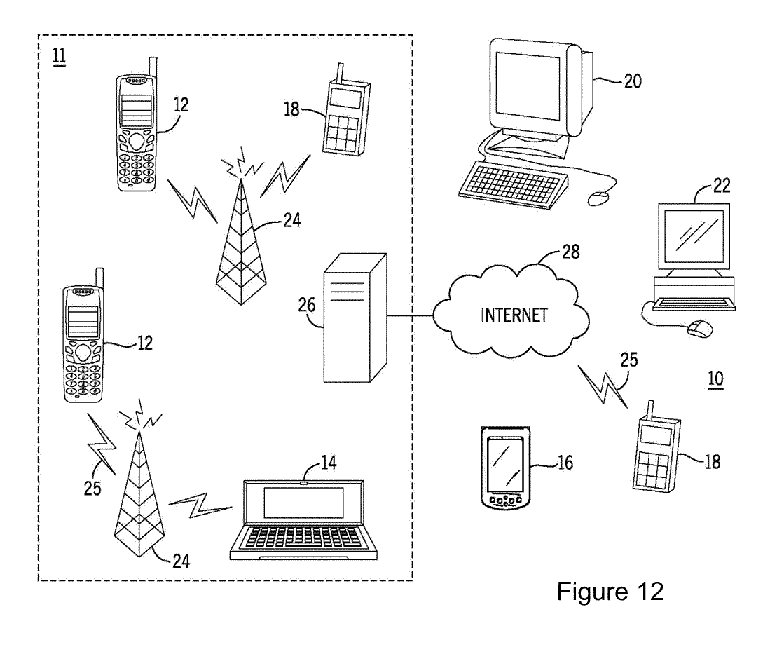

FIG. 12 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 12 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

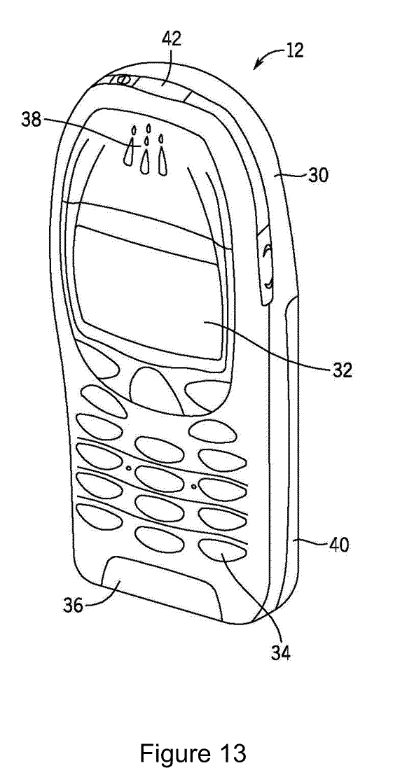

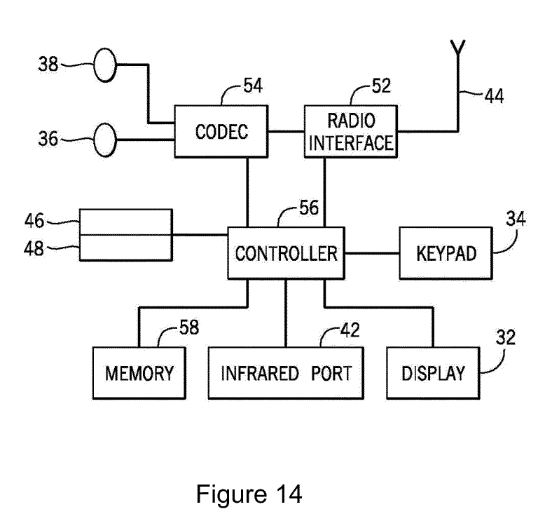

FIGS. 13 and 14 show one representative electronic device 28 which may be used as a network node in accordance to the various embodiments of the present invention. It should be understood, however, that the scope of the present invention is not intended to be limited to one particular type of device. The electronic device 28 of FIGS. 13 and 14 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

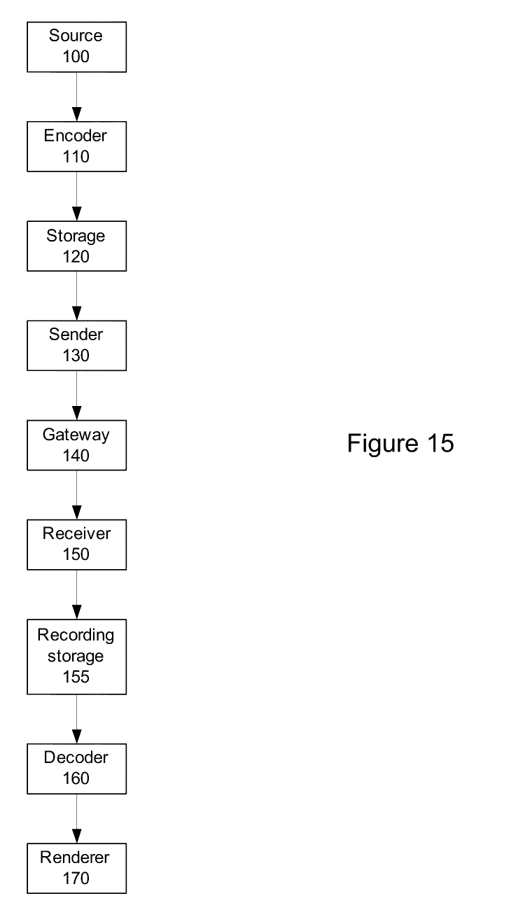

FIG. 15 is a graphical representation of a generic multimedia communication system within which various embodiments may be implemented. As shown in FIG. 15, a data source 100 provides a source signal in an analog, uncompressed digital, or compressed digital format, or any combination of these formats. An encoder 110 encodes the source signal into a coded media bitstream. It should be noted that a bitstream to be decoded can be received directly or indirectly from a remote device located within virtually any type of network. Additionally, the bitstream can be received from local hardware or software. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 15 only one encoder 110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

If the media content is encapsulated in a container file for the storage 120 or for inputting the data to the sender 130, the sender 130 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISO Base Media File Format, for encapsulation of the at least one of the contained media bitstream on the communication protocol.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer or an RTP translator and typically acts as an endpoint of an RTP connection.

The system includes one or more receivers 150, typically capable of receiving, de-modulating, and de-capsulating the transmitted signal into a coded media bitstream. The coded media bitstream is transferred to a recording storage 155. The recording storage 155 may comprise any type of mass memory to store the coded media bitstream. The recording storage 155 may alternatively or additively comprise computation memory, such as random access memory. The format of the coded media bitstream in the recording storage 155 may be an elementary self-contained bitstream format, or one or more coded media bitstreams may be encapsulated into a container file. If there are multiple coded media bitstreams, such as an audio stream and a video stream, associated with each other, a container file is typically used and the receiver 150 comprises or is attached to a container file generator producing a container file from input streams. Some systems operate “live,” i.e. omit the recording storage 155 and transfer coded media bitstream from the receiver 150 directly to the decoder 160. In some systems, only the most recent part of the recorded stream, e.g., the most recent 10-minute excerption of the recorded stream, is maintained in the recording storage 155, while any earlier recorded data is discarded from the recording storage 155.

The coded media bitstream is transferred from the recording storage 155 to the decoder 160. If there are many coded media bitstreams, such as an audio stream and a video stream, associated with each other and encapsulated into a container file, a file parser (not shown in the figure) is used to decapsulate each coded media bitstream from the container file. The recording storage 155 or a decoder 160 may comprise the file parser, or the file parser is attached to either recording storage 155 or the decoder 160.

The coded media bitstream is typically processed further by a decoder 160, whose output is one or more uncompressed media streams. Finally, a renderer 170 may reproduce the uncompressed media streams with a loudspeaker or a display, for example. The receiver 150, recording storage 155, decoder 160, and renderer 170 may reside in the same physical device or they may be included in separate devices.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
receiving a bitstream including a sequence of access units;
decoding a first decodable access unit in the bitstream;
determining whether the next decodable access unit following the first decodable access unit in the bitstream is able to be decoded before an output time of the next decodable access unit;
skipping decoding of the next decodable access unit based on determining that the next decodable access unit is not able to be decoded before the output time of the next decodable access unit; and
skipping decoding of any access units depending on the next decodable access unit.

2. The method of claim 1, further comprising:
selecting a first set of coded data units from the bitstream,
wherein a sub-bitstream comprises a part of the bitstream including the first set of coded data units, the sub-bitstream is decodable into a first set of decoded data units, and the bitstream is decodable into a second set of decoded data units,
wherein a first buffering resource is sufficient to arrange the first set of decoded data units into an output order, a second buffering resource is sufficient to arrange the second set of decoded data units into an output order, and the first buffering resource is less than the second buffering resource;

3. The method of claim 2, wherein the first buffering resource and the second buffering resource are in terms of an initial time for decoded data unit buffering.

4. The method of claim 2, wherein the first buffering resource and the second buffering resource are in terms of an initial buffer occupancy for decoded data unit buffering.

5. The method of claim 1, wherein each access unit is one of an IDR access unit, an SVC access unit or an MVC access unit containing an anchor picture.

6. An apparatus, comprising:
a processor; and
a memory unit communicatively connected to the processor and including:
computer code for receiving a bitstream including a sequence of access units;
computer code for decoding a first decodable access unit in the bitstream;
computer code for determining whether the next decodable access unit following the first decodable access unit in the bitstream is able to be decoded before an output time of the next decodable access unit;
computer code for skipping decoding of the next decodable access unit based on determining that the next decodable access unit is not able to be decoded before the output time of the next decodable access unit; and
computer code for skipping decoding of any access units depending on the next decodable access unit.

7. The apparatus of claim 6, further comprising:
computer code for selecting a first set of coded data units from the bitstream,
wherein a sub-bitstream comprises a part of the bitstream including the first set of coded data units, the sub-bitstream is decodable into a first set of decoded data units, and the bitstream is decodable into a second set of decoded data units,
wherein a first buffering resource is sufficient to arrange the first set of decoded data units into an output order, a second buffering resource is sufficient to arrange the second set of decoded data units into an output order, and the first buffering resource is less than the second buffering resource;

8. The apparatus of claim 7, wherein the first buffering resource and the second buffering resource are in terms of an initial time for decoded data unit buffering.

9. The apparatus of claim 7, wherein the first buffering resource and the second buffering resource are in terms of an initial buffer occupancy for decoded data unit buffering.

10. The apparatus of claim 6, wherein each access unit is one of an IDR access unit, an SVC access unit or an MVC access unit containing an anchor picture.

11. A computer-readable medium having a computer program stored thereon, the computer program comprising:
computer code for receiving a bitstream including a sequence of access units;
computer code for decoding a first decodable access unit in the bitstream;
computer code for determining whether the next decodable access unit following the first decodable access unit in the bitstream is able to be decoded before an output time of the next decodable access unit;
computer code for skipping decoding of the next decodable access unit based on determining that the next decodable access unit is not able to be decoded before the output time of the next decodable access unit; and
computer code for skipping decoding of any access units depending on the next decodable access unit.

12. The computer-readable medium of claim 11, further comprising:
computer code for selecting a first set of coded data units from the bitstream,
wherein a sub-bitstream comprises a part of the bitstream including the first set of coded data units, the sub-bitstream is decodable into a first set of decoded data units, and the bitstream is decodable into a second set of decoded data units,
wherein a first buffering resource is sufficient to arrange the first set of decoded data units into an output order, a second buffering resource is sufficient to arrange the second set of decoded data units into an output order, and the first buffering resource is less than the second buffering resource;

13. The computer-readable medium of claim 12, wherein the first buffering resource and the second buffering resource are in terms of an initial time for decoded data unit buffering.

14. The computer-readable medium of claim 12, wherein the first buffering resource and the second buffering resource are in terms of an initial buffer occupancy for decoded data unit buffering.

15. The computer-readable medium of claim 11, wherein each access unit is one of an IDR access unit, an SVC access unit or an MVC access unit containing an anchor picture.
